(19) United States
(12) Patent Application Publication
(10) Pub. No.: US 2012/0125386 A1
(43) Pub. Date: May 24, 2012

(54) WASHING UNIT FOR TURBOPROPS OF AIRCRAFTS

(75) Inventor: Marco Bertolucci, La Spezia (IT)

(73) Assignee: S.I.A. SOCIETÀ IDEE AVIONICHE S.R.L., Firenze (IT)

(21) Appl. No.: 13/388,573

(22) PCT Filed: Aug. 3, 2010
(86) PCT No.: PCT/IB10/53512

§ 371 Date: Feb. 2, 2012

(30) Foreign Application Priority Data
Aug. 6, 2009 (IT) FI2009A000181

(51) Int. Cl. B08B 3/04; B08B 3/00

(52) U.S. Cl. 134/58 R; 134/186; 134/109

(57) ABSTRACT

A washing unit for turboprops, in particular of aircrafts, characterised in that it comprises at least one hydraulic pump (6, 7) which draws cleaning liquid contained in one or more external tanks in order to spill that liquid from a supply outlet (12) with a predetermined pressure and a predefined flow.

### FIELD OF THE INVENTION

The present invention concerns the field of washing systems for turboprops of helicopters and aircrafts, and in particular it regards an autonomous washing unit for a desalinating and performance restoring wash for turboprops, said washing unit having a size such as to be easily useable both in a hangar and on board of the aircraft.

### BACKGROUND ART

As known, in their motion, the blades and the rotor of a turboprop of an aircraft or a helicopter are subject to surface deposits of impurities coming both from the environment, like for example dust, fertilisers, salty deposits, etc., and from the craft itself, for example impurities deriving from exhaust oil vapours from the compressor.

In order to ensure the maximum efficiency it is thus necessary to periodically wash the turboprop, in particular its turbine and/or its compressor, with distilled water and/or detergents, so as to eliminate the aforementioned deposits.

Washing systems presently known can essentially be split into two categories: hangar systems and system that can be transported on board of the aircraft.

Hangar-based apparatuses use compressed air or nitrogen, contained in special pressurised tanks, to push a high pressure flow of distilled water and/or detergent inside the turbine and/or its compressor. These washing systems have large dimensions and weight and their possible movements, by ground or by air, can only be carried out by using big sized cargo planes. A further limiting factor for the transportation and use of these washing systems is the fact that in order to work they require a generator unit or a direct connection with the electrical power distribution network.

In addition to these problems there are also those in connection with the maintenance and operation costs. Indeed, the apparatus needs periodic refills of nitrogen or air, and it must be subjected to annual tests that involve a period out of use.

With regard to the transportable apparatuses currently in use, it is possible to identify two different ways of operating, one that uses the same operating principle as hangar-based washing systems, i.e. pressurisation of distilled water and detergent, and one that uses a precharged hydropneumatic accumulator (like for example the apparatus described in International patent application n. WO2006123387).

These apparatuses, although they ensure greater versatility deriving from their small size, do however have limitations of usage due to performance that, in certain conditions, is inadequate.

In particular, transportable apparatuses that use the pressurisation of distilled water and detergent need to be power supplied by the electricity distribution network, they need to be continuously refilled with air or nitrogen, and they have washing parameters that depend directly upon the amount of air or nitrogen present in the tanks.

With regard to the apparatuses with a hydropneumatic accumulator, they have some limitations in terms of amounts of liquid delivered and of delivery pressure that do not allow them to be used to wash turbines and compressors of large-size aircrafts.

### SUMMARY OF THE INVENTION

The object of the present invention is to offer a versatile and multi-purpose apparatus, with which it is possible to satisfy the washing parameters prescribed by the manufacturers of all engines used on turboprop helicopters and aircrafts, both civil and military, being able to easily adjust the delivery pressure (from 0 to 80 psi) and the flow of water and/or detergent (from 0 to 30 l/min).

Such an object is achieved with the washing unit according to the present invention, having the essential characteristics defined by the first of the attached claims.

### BRIEF DESCRIPTION OF THE DRAWINGS

The characteristics and advantages of the washing unit according to the present invention will become apparent from the following description of an embodiment thereof, given as a non-limiting example, with reference to the attached drawings, in which:

FIG. 1 represents a hydraulic circuit diagram of a washing unit according to the invention;

FIG. 2 shows a side view of the washing unit according to the invention, in open configuration ready for use;

FIG. 3 is a top view of the washing unit of FIG. 2, showing a control panel;

FIG. 4 shows a schematic side view of a cart to be associated with the washing unit according to the invention in a configuration for use in hangar;

FIG. 5 is a schematic front view of the cart according to FIG. 4; and

FIG. 6 represents a schematic top view of the cart in FIGS. 4 and 5.

### DETAILED DESCRIPTION OF THE INVENTION

With reference to the above figures, the invention is suitable both for on field uses, i.e. to be easily transportable in the areas of operation, and for use in hangars.

The washing unit is housed in a transportable pressurised case 1 (class of protection IP67 DS 81-41 and severity level NATO 1 and 2—MILITARY “J”) divided into two watertight compartments 4 and 5 and possibly having a plurality of wheels 40, for example two, which allow it to be transported as a trolley.

FIG. 3 shows a control panel 3 with which the user manages the washing of the turboprop. The panel shuts on the top side the actual containment space of the case and becomes accessible opening a lid 2 of the case 1. As can be seen from the figures the panel is divided into two parts corresponding to the two watertight compartments 4 and 5 of the case 1. On the part of the panel corresponding to the compartment 4 there are the controls and the instruments for controlling the hydraulic system, in particular: a quick-clutch drawing inlet 11; a quick-clutch delivery outlet 12; a control 13a for a flow regulator 13; a control 14a for a pressure regulator 14; a check manometer 15; a display 16a of an electronic flow counter 16.

On the remaining part of the panel, i.e. that relative to the compartment 5, there are arranged the electric controls, i.e.: a start/stop button 17; an emergency button 18; a connector 19 for 115-230 VDC 50/60 Hz power supply; a connector 20 for 24-28 VDC power supply; a display 21 that shows the battery status (the batteries are not shown); a security fuse 22; a selector 23 for the operation of the pumps (one of the two or both, as will become clear shortly); an on/off general switch 24.

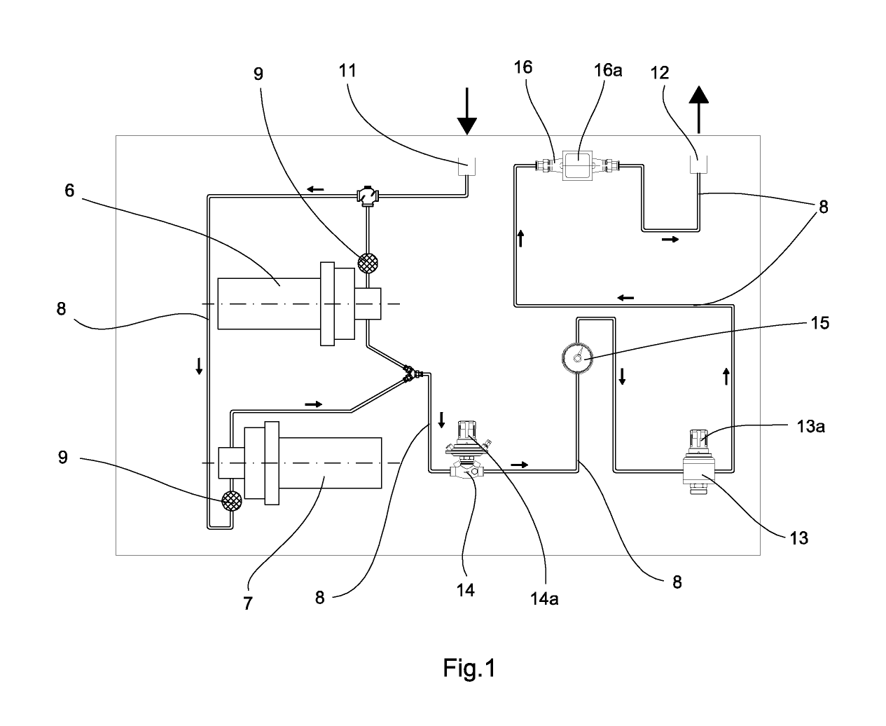

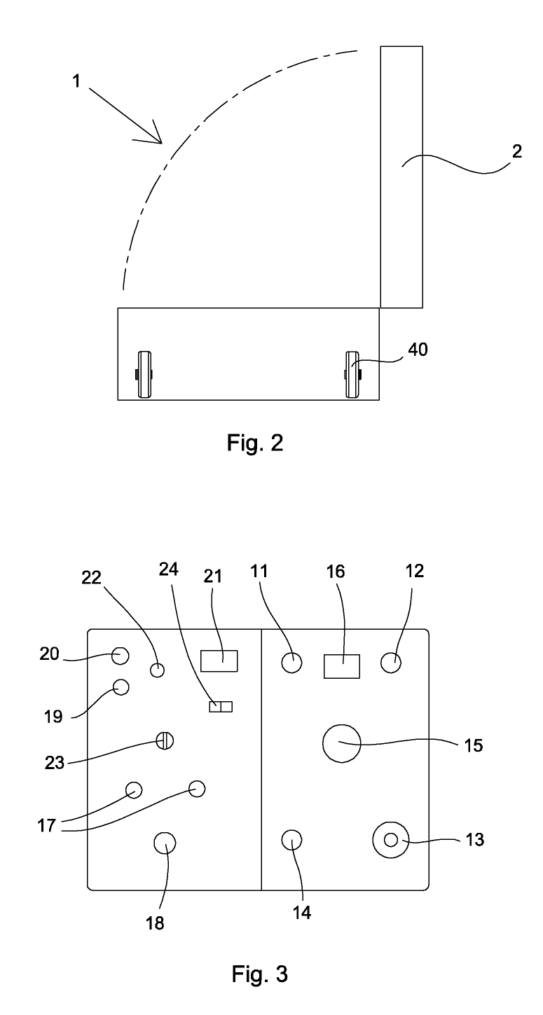

Beneath the two distinct functional sections in which the panel is divided a hydraulic system and an electric system are therefore arranged, respectively, in the two watertight compartments 4 and 5. In particular, with reference to FIG. 1, inside the compartment 4, under the relative panel, two hydraulic diaphragm pumps 6 and 7 (24/28 VDC) are housed, having high pressure (0-80 psi) and large flow rate (0-30 l/min), together with pipes 8, other hydraulic components and fittings of the system.

In the adjacent compartment (not shown in the figures), a multi-voltage power supply is arranged, complete with integrated group of batteries (24/28 VDC—40 Ah) such as to allow the system to have long operating autonomy (at least two hours) in the case of on field use, being adapted to be recharged directly from the service socket of the aircraft during a transfer flight.

As shown in FIG. 1, the liquid, drawn by the pumps 6, 7 (depending on the specific requirements, just one or both of them can be used), enters through the drawing inlet 11, goes through the pipes 8 until it comes out from the supply outlet 12 going through, in order, filtering elements 9, the pumps 6, 7, a fitting to which the pressure regulator 14 is connected, the manometer 15, a further fitting to which the flow regulator 13 is connected, and the electronic flow counter 16.

With this particular hydraulic system the user can adjust the flow rate and the flow of liquid coming out. The outlet flow counter, moreover, ensures that the amount of liquid delivered is controlled.

The low weight and small size allow maximum air-transportability, even on small aircrafts, with the consequent possibility of use in remote operating areas without energy sources.

The system does not need tanks and/or accumulators since the distilled water or the detergent mixture necessary for washing to desalinate, or for restoring the performance of the turbine, is sucked in from any external container.

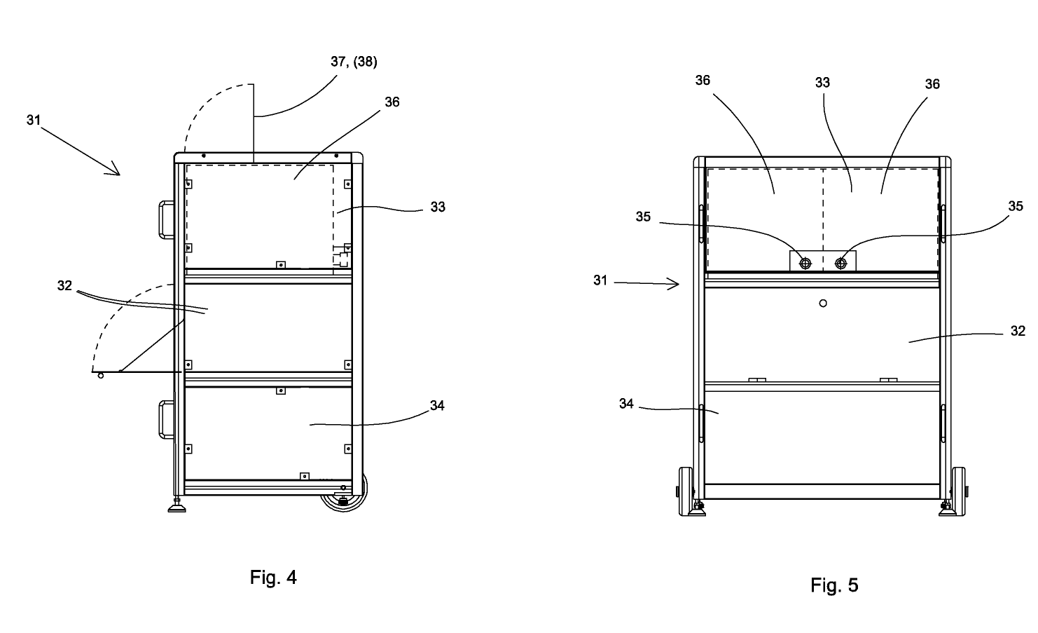

In case of use in a hangar a particular set-up is provided, shown in FIGS. 4 to 6, consisting of an upright metallic cart 31 with compartments placed one above the other.

The unit is housed in an extractable drawer 32 positioned in the central part of the cart.

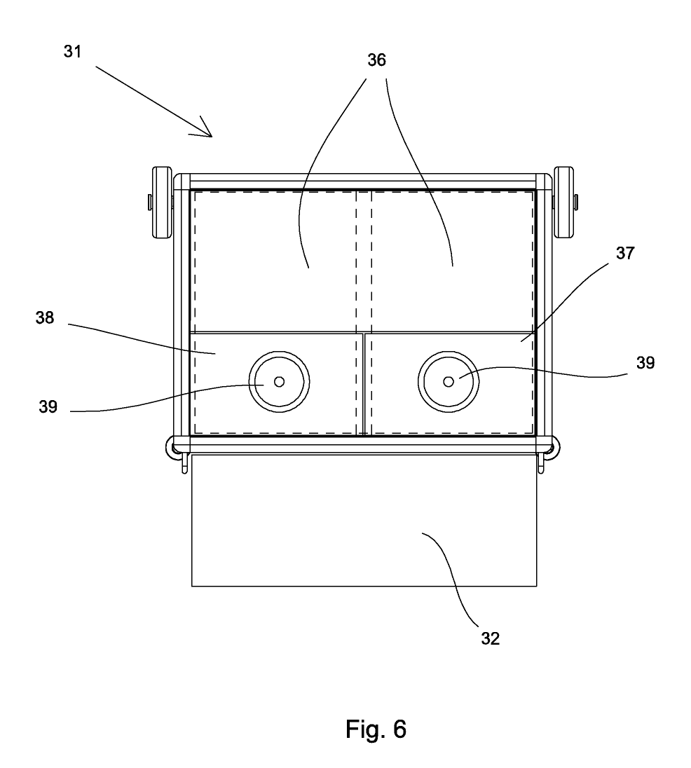

In an upper compartment 33 two tanks 36 are arranged, for example made of PVC, one for the distilled water and one for the detergent. On the front side of each tank, i.e. the one facing towards the side of the cart from which the extractable drawer comes out, a spout 35 is arranged with which, through a delivery hose, the washing system takes the liquids. So as to allow the tanks to be refilled, the top of the cart 31 is equipped with two lids 37 and 38 at which the tanks each have a refill cap 39 (FIG. 6).

Finally, when not in use, the hoses and the different fittings for the connection to the turbines are arranged in a lower compartment 34. The operating principle and the washing parameters that can be obtained are the same as the system in the “on field” configuration, with the difference that the pumps, in this case, work in wash-down mode, i.e. they do not suck in the liquid from the tank but, since the tanks are arranged above the system, they take the liquid exploiting the force of gravity.

In this way it is possible to have a complete apparatus contained in a single cart.

From what has been described above, it is clear that the washing unit according to the invention allows any turbine or compressor of an aircraft to be washed with the maximum efficiency and in any location of application it is used, satisfying the washing parameters prescribed by the manufacturers of all the engines used on civil or military aircrafts, with it being possible to adjust the delivery pressure and the flow easily and with maximum efficiency.

Unlike known apparatuses, the unit is entirely contained in a case and only requires a generic tank from which to draw the detergent or the distilled water. Moreover, there is no use of compressed air/nitrogen to push the liquids used or of precharged accumulators, but pumps with high pressure and large flow rate are used that, by means of the particular hydraulic system, can operate in self-priming or wash-down mode.

With a single washing system the washing parameters required by the manufacturers of turboprops can be satisfied since the flow rate and pressure of the liquids can be adjusted mechanically by the user without the help of electronic management circuit boards.

Thanks to the power supply/accumulator with which it is equipped, the system is suitable for the so-called “extreme field use”, i.e. it can be used in operating areas without energy sources.

The washing system enclosed in the transportation case with protection class IP67 DS 81-41 and severity level NATO 1 and 2—MILITARY “J”, determines the degree of protection from possible collisions and makes the unit watertight and unsinkable till a weight of 36.7 kg. With regard to the cart on which the system is placed for use in a hangar, it can differ from the one described here, provided that the same performance is ensured.

The present invention has been described up to now with reference to a preferred embodiments. It should be understood that there can be other embodiments falling within the same inventive concept, as defined by the scope of protection of the attached claims.

1. A washing unit for turboprops, in particular of aircrafts, comprising at least one hydraulic pump which draws cleaning liquid contained in one or more external tanks in order to spill that liquid from a supply outlet with a predetermined pressure and a predefined flow.

2. The washing unit according to claim 1, wherein said unit comprises a transportable case-shaped frame defining two watertight compartments one of which contains said at least one hydraulic pump with the associated hydraulic circuitry, the second comprising at least one power supply/battery for the electric feeding with a circuit for charge and discharge management and the associated connectors.

3. The washing unit according to claim 2, wherein said hydraulic circuitry comprises pipes, filtering elements, a connector to which a pressure regulator is connected, a connector connected to a manometer, a further connector to which a flow regulator is attached and an electronic flow counter.

4. The washing unit according to claim 2, wherein said pumps are two pumps 24/28 VDC for high pressure delivery and big flow-rate of flow, arranged in parallel and selectively operable.

5. The washing unit according to claim 3, wherein said compartments are intercepted on the top by a control panel where hydraulic controls are arranged over said compartment and electrical controls are arranged over said compartment, said control panel being accessible at the opening of said case-shaped frame.

6. The washing unit according to claim 5, wherein said hydraulic controls comprise a quick-clutch drawing inlet; a quick-clutch supply outlet; a control for said flow regulator; a control for said pressure regulator; said manometer and a display of said electronic flow counter.

7. The washing unit according to claim 5, wherein said electric controls comprise a start/stop button; an emergency button; a connector for 115-230 VDC 50/60 Hz power supply; a connector for 24-28 VDC power supply; a display showing the battery status; a security fuse; an operating pumps selector; and an on/off unit switch.

8. The washing unit according to claim 1, associated or associable to a metallic vertical cart with three compartments placed one above the other, said compartments comprising an upper drawer where tanks for containment of detergent or distilling water are placed, an extractable drawer positioned in the middle part of said cart used for housing the unit and a lower drawer where washing accessories are kept.

9. The washing unit according to claim 2, wherein said case-shaped frame is a transportable bag protection class IP67 DS 81-41 and severity level NATO 1 & 2 and MILITARY “J”, which makes the unit watertight and unsinkable till a 36 Kg weight.
